(19) United States
(12) Patent Application Publication
(10) Pub. No.: US 2017/0228508 A1
(43) Pub. Date: Aug. 10, 2017

(54) PROXIMITY-BASED MEDICAL DATA RETRIEVAL

(71) Applicant: Covidien LP, Mansfield, MA (US)

(72) Inventors: HENRY DEAN COOK, Lyons, CO (US); GEORGE NIKOLAI KOTULA, Longmont, CO (US)

(21) Appl. No.: 15/040,060

(22) Filed: Feb. 10, 2016

(51) Int. Cl. G06F 19/00; H04W 4/02; H04W 64/00; H04W 8/00

(52) U.S. Cl. CPC G06F 19/3406; H04W 8/005; H04W 4/023; H04W 64/00

(57) ABSTRACT

Methods, systems, and devices for proximity-based retrieval of medical data are described. Methods may include receiving, at a mobile device, a first beacon signal from a first medical monitoring device, determining a proximity between the mobile device and the first medical monitoring device based on the first beacon signal, and determining whether to receive medical data collected by the first medical monitoring device based on the determined proximity. Systems may include a medical monitoring device coupled with a patient and configured to collect medical data associated with the patient and transmit a beacon signal and a mobile device configured to determine whether to receive the medical data collected by the medical monitoring device. The determination may be based on a proximity between the medical monitoring device and the mobile device and the proximity may be determined based on the beacon signal.

### BACKGROUND

The following relates generally to wireless patient monitoring systems and medical sensors, and more specifically to proximity-based medical data retrieval. In a medical care facility such as a hospital, the condition of a patient may be monitored using one or more medical monitoring devices (e.g., medical sensors) that are attached to the patient. The medical monitoring devices may monitor a variety of physiological parameters of the patient such as heart rate, blood oxygen saturation levels, respiratory rate, glucose level, etc. The medical monitoring devices may be portable medical sensors (e.g., wireless). Thus, a patient may move freely throughout the medical care facility while being monitored.

In some cases, a clinician who encounters a patient wearing a portable medical monitoring device may desire access to the data collected by the medical monitoring device. But the clinician may have to physically operate the monitoring device to access the data, which may take time and/or cause discomfort for the patient. Alternatively, the clinician may attempt to access the data by setting up a wireless connection to receive the data at a display device carried by the clinician. However, the data from the medical monitoring device in question may be received along with data from numerous other medical monitoring devices, causing the clinician to sift through irrelevant data to find the data associated with the patient. Delays in clinician access to medical monitoring device data may reduce the amount of time the clinician can focus on treating the patient.

### SUMMARY

The described features generally relate to methods and devices for proximity-based retrieval of medical data to reduce the amount of time a clinician spends trying to access the medical data of a particular patient. For example, medical data may be collected by a medical monitoring device after it is determined that the medical monitoring device is close to (e.g., within a threshold distance from) a mobile device carried by a clinician. The proximity of the medical monitoring device may be determined by assessing the signal strength of a beacon signal transmitted by the medical monitoring device. In some embodiments, the mobile device may determine whether to receive medical data collected by the medical monitoring device by sensing a clinician's response to a user prompt. The user prompt may ask the clinician if they would like to access the medical data collected by the medical monitoring device. If the clinician indicates that access to the medical data is desired, the mobile device may receive the medical data from the medical monitoring device directly or indirectly (e.g., via a server which stores the medical data).

In certain situations, a medical monitoring device may be coupled with a patient as the patient moves about a health care facility. In such cases, to reduce the amount of time it takes a clinician to access the data collected by the medical monitoring device, a mobile device carried by the clinician may automatically prompt the clinician to determine if the clinician would like to receive the data. The prompt may be displayed when the mobile device determines that the medical monitoring device is within a threshold distance. In accordance with methods described herein, medical data may be retrieved by determining a proximity between a medical monitoring device and the mobile device based at least in part on a beacon signal received at the mobile device from the medical monitoring device and determining whether to receive medical data collected by the medical monitoring device based at least in part on the determined proximity.

Embodiments of systems and devices for associating a patient with a medical sensor are also described. In accordance with certain aspects, a system includes a medical monitoring device coupled with a patient and configured to collect medical data associated with the patient and transmit a beacon signal and a mobile device configured to determine whether to receive the medical data collected by the medical monitoring device. The determination may be based at least in part on a proximity between the medical monitoring device and the mobile device which is determined based at least in part on the beacon signal.

Certain embodiments of the present disclosure may include some, all, or none of the above advantages or features. One or more other technical advantages or features may be readily apparent to those skilled in the art from the figures, descriptions, and claims included herein.

Moreover, while specific advantages or features have been enumerated above, various embodiments may include all, some, or none of the enumerated advantages or features.

### BRIEF DESCRIPTION OF THE DRAWINGS

FIG. 1 illustrates an example of a wireless sensor system that supports proximity-based medical data retrieval in accordance with aspects of the present disclosure;

FIG. 2 illustrates an example of a wireless sensor system that supports proximity-based medical data retrieval in accordance with aspects of the present disclosure;

FIG. 3 illustrates an example of a wireless sensor system that supports proximity-based medical data retrieval in accordance with aspects of the present disclosure;

FIG. 4 illustrates an example of a process flow in a system that supports proximity-based medical data retrieval in accordance with aspects of the present disclosure;

FIG. 5 shows a block diagram of a wireless device that supports proximity-based medical data retrieval in accordance with aspects of the present disclosure;

FIG. 6 shows a block diagram of a wireless device that supports proximity-based medical data retrieval in accordance with aspects of the present disclosure;

FIG. 7 shows a block diagram of a wireless device that supports proximity-based medical data retrieval in accordance with aspects of the present disclosure;

FIG. 8 illustrates a method for proximity-based medical data retrieval in accordance with aspects of the present disclosure;

FIG. 9 illustrates a method for proximity-based medical data retrieval in accordance with aspects of the present disclosure; and

FIG. 10 illustrates a method for proximity-based medical data retrieval in accordance with aspects of the present disclosure.

### DETAILED DESCRIPTION

In accordance with various embodiments described herein, medical data from a medical monitoring device may be accessed by a clinician based on the proximity of the medical monitoring device to the clinician. The medical monitoring device may collect data associated with a patient to which the medical monitoring device is coupled. When the proximity between the medical monitoring device and a mobile device carried by the clinician satisfies a threshold distance, the mobile device may determine whether to receive medical data from the medical monitoring device. For example, the mobile device may display a user prompt that asks the clinician if they would like to access the medical data. If the clinician responds in the affirmative, the mobile device may receive and display the medical data. Reception of data at the wireless device may be filtered so that the mobile device refrains from receiving irrelevant data (e.g., data from un-targeted medical monitoring devices). For example, the wireless device may refrain from receiving data from medical monitoring devices that are far from the clinician, or coupled with patients unassociated with the clinician.

Upon determining that the clinician would like to access the medical data collected by a medical monitoring device, the mobile device may select the source from which to receive the data. For instance, the mobile device may request the data from the medical monitoring device directly. In another example, the mobile device may request the data from a remote server which has access to the data. In some cases, the mobile device will receive the data from the medical monitoring device and relay the data to the remote server. In some cases, the mobile device may receive the data from the medical monitoring device and receive supplemental data (e.g., data collected by other medical monitoring devices associated with the patient) from the remote server.

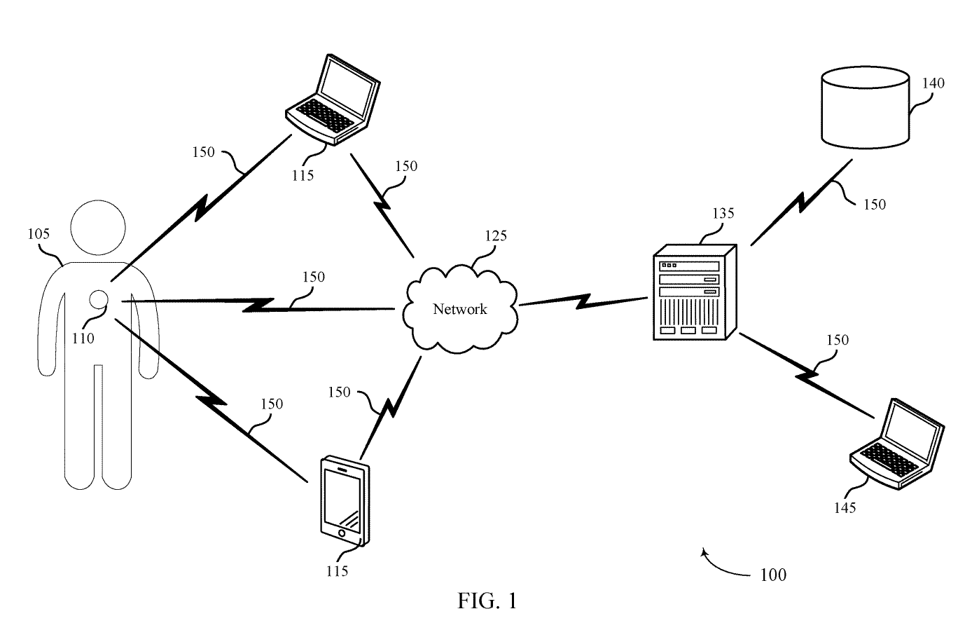

FIG. 1 illustrates an example of a wireless patient monitoring system 100 in accordance with various embodiments of the present disclosure. The wireless patient monitoring system 100 includes a patient 105 wearing, carrying, or otherwise physically coupled with a medical monitoring device 110. Although a single medical monitoring device 110 is shown, multiple medical monitoring devices 110 may be worn by the patient 105. The patient 105 may be a patient in a hospital, nursing home, home care, or other medical care facility. The medical monitoring device 110 may transmit signals via wireless communications links 150 to local computing devices 115 or to a network 125. For example, the medical monitoring device 110 may be capable of transmitting data it has collected to other devices (e.g., local computing device 115 or network 125) for analysis, storage, and/or display. A medical monitoring device 110 may also transmit advertisements that indicate information associated with medical monitoring device 110. For example, the medical monitoring device 110 may broadcast a beacon signal that conveys identity information and proximity detection information.

Local computing device 115 may be a wireless device such as a tablet, cellular phone, personal digital assistant (PDA), dedicated receiver or other similar device or a spatially distributed network of devices configured to receive signals from the medical monitoring device 110. Local computing device 115 may be a wireless laptop computer or mobile computer station also configured to receive signals from the medical monitoring device 110. In accordance with various embodiments, at least one of the local computing devices 115 may be configured to receive a broadcast beacon from the medical monitoring device 110 worn by the patient 105. In some embodiments, information conveyed by the broadcast beacon may be used by the local computing device 115 to determine the proximity of the medical monitoring device 110. The local computing device 115 may determine whether to receive data from the medical monitoring device 110 based at least in part on the determined proximity. For example, if the medical monitoring device 110 is within a threshold distance (e.g., 1 meter), the local computing device 115 may display a user prompt asking a user (e.g., a clinician) if the data should be receive and displayed. If the medical monitoring device 110 is outside of the threshold distance, the local computing device 115 may not display the user prompt and may refrain from receiving the data.

The medical monitoring device 110 may also communicate directly with a remote server 135 via the network 125. The remote server 135 may be a server or a nurses station located within the hospital or in a remote location. The remote server 135 may be in further communication with one or more remote computing devices 145, thus allowing a clinician to remotely monitor the patient 105. The remote server 135 may also be in communication with various remote databases 140 where the collected data may be stored. For example, data collected from medical monitoring device 110 may be stored. In some cases, network 125 may be used to access a website that includes data from multiple medical monitoring devices 110 associated with a patient 105.

The medical monitoring device 110 may include one or more sensors configured to collect a variety of physiological parameters as well as information related to the location and movement of the patient 105. For example, the medical monitoring device 110 may include a pulse oximetry (SpO2) sensor, a heart rate sensor, a blood pressure sensor, an electrocardiogram (ECG) sensor, a respiratory rate sensor, a glucose level sensor, a body temperature sensor, an accelerometer, a global positioning sensor, a sensor which triangulates position from multiple local computing devices 115 and any other sensor configured to collect physiological, location, or motion data.

The medical monitoring device 110 may be physically coupled with the patient 105 in a variety of ways depending on the data being collected. For example, the medical monitoring device 110 may be coupled to the user's chest, worn around the user's wrist, or attached to the user's finger. The data collected by the medical monitoring device 110 may be wirelessly conveyed to either the local computing devices 115 or to the remote computing device 145 (via the network 125 and remote server 135). Data transmission may occur via, for example, frequencies appropriate for near field communications, a personal area network (such as Bluetooth, Bluetooth Low Energy (BLE), or IR communications) or local (e.g., wireless local area network (WLAN)) or wide area network (WAN) frequencies such as radio frequencies specified by IEEE standards (e.g., IEEE 802.15.4 standard, IEEE 802.11 standard (Wi-Fi), IEEE 802.16 standard (WiMAX), etc.).

In accordance with various embodiments, methods and apparatuses are described for proximity-based data retrieval from a medical monitoring device 110. As described in detail below, the retrieval may include receiving, at a local computing device 115, a beacon signal from a medical monitoring device 110 and determining the proximity of the medical monitoring device 110 from information included in the beacon signal. Upon determination of the proximity, the local computing device 115 can implement a prioritization scheme to determine whether the to receive data from the medical monitoring device 110. In accordance with various embodiments, the prioritization scheme may be based on a proximity of another medical monitoring device 110, an alarm associated with the medical monitoring device 110, or a relationship between the patient 105 and a particular clinician.

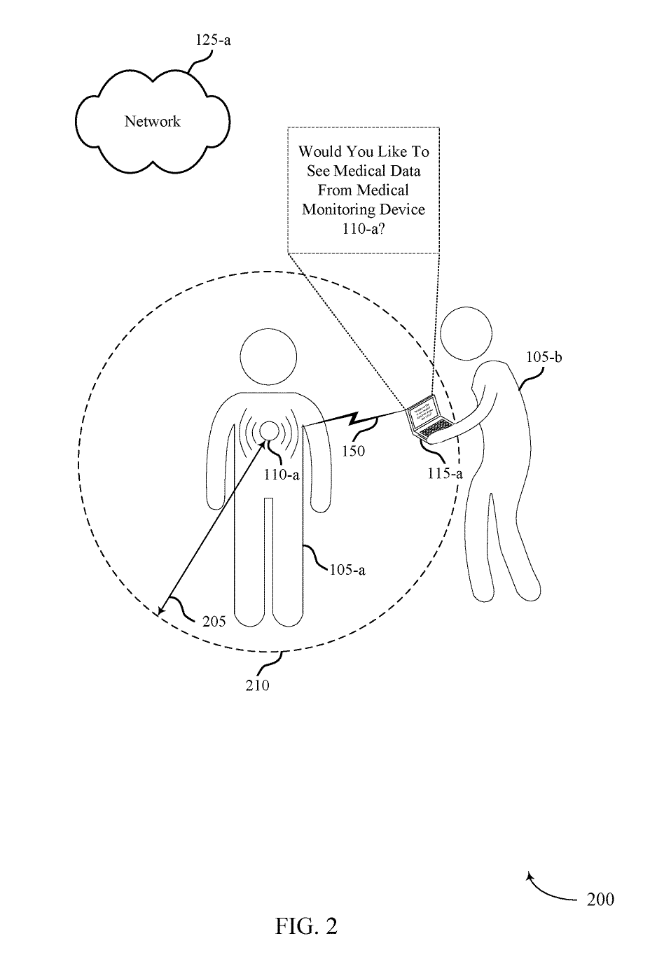

FIG. 2 illustrates an example of a wireless patient monitoring system 200 for proximity-based medical data retrieval. The wireless patient monitoring system 200 includes a medical monitoring device 110-a, which may be an example of medical monitoring device 110 described with reference to FIG. 1. The patient monitoring system may also include a mobile device 115-a which may be an example of a local computing device 115 described with reference to FIG. 1. Medical monitoring device 110-a and local computing device 115-a may each be capable of communicating with network 125-a, which may be an example of a network 125 described with reference to FIG. 1. Mobile device 115-a may determine whether to receive data collect by medical monitoring device 110-a based on the proximity of medical monitoring device 110-a and/or user input. Mobile device 115-a may receive the data collected by medical monitoring device 110-a directly from medical monitoring device 110-a or from network 125-a. In some cases, mobile device 115-a may receive the data from medical monitoring device 110-a and pass it on to the network 125-a.

Medical monitoring device 110-a may collect medical (e.g., physiological) data associated with patient 105-a. Medical monitoring device 110-a may store the medical data, and, in some cases, transmit the medical data to network 125-a. Medical monitoring device 110-a may broadcast beacon signals that are receivable by mobile device 115-a. A beacon signal may be transmitted periodically, or upon a trigger, and may include information that facilitates retrieval of the medical data collected by medical monitoring device 110-a. For example, the beacon signal may include information about the identity of monitoring device 110-a. In some cases, the identity information may be a randomly selected sequence of letters and/or numbers; thus, devices that know the correspondence between the sequence and the medical monitoring device 110-a may determine the identity of medical monitoring device 110-a from the beacon signal. In other cases, the identity information may be encrypted or otherwise protected. A device that recognizes the identity of medical monitoring device 110-a may associate medical monitoring device 110-a with a patient (e.g., patient 105-a). The device may also determine the device-type of medical monitoring device 110-a.

A beacon signal broadcast from medical monitoring device 110-a may also include proximity detection information. The proximity detection information may be used by mobile device 115-a to determine the proximity of medical monitoring device 110-a (e.g., the distance between medical monitoring device 110-a and mobile device 115-a). In some cases, the proximity detection information includes information pertaining to signal strength. For example, the proximity detection information may include a received signal strength indicator (RSSI) value. The RSSI value may be the signal strength expected to be measured when a device is at a threshold distance 205 (e.g., 1 meter) from medical monitoring device 110-a. For example, mobile device 115-a may receive a beacon signal from medical monitoring device 110-a and measure the signal strength of the beacon signal to determine the RSSI of the signal. The mobile device 115-a may then compare the measured RSSI to the expected RSSI value conveyed by the signal to determine the proximity of medical monitoring device 110-a. For instance, if the measured RSSI is greater than the expected RSSI, the mobile device 115-a may determine that mobile device 115-a is within the threshold distance 205 (e.g., 1 meter) from medical monitoring device 110-a. If the measured RSSI is less than the expected RSSI, the mobile device 115-a may determine that mobile device 115-a is outside of threshold distance 205. In some cases, the mobile device 115-a may implement a smoothing algorithm when measuring signal strength and determining RSSI. The smoothing algorithm may account for spikes in RSSI (e.g., due to interference and/or noise) by averaging the sampled data (e.g., measured signal strength).

In some cases, the threshold distance 205 may define a coverage area of medical monitoring device 110-a in which devices may determine whether or not to receive data collected by medical monitoring device 110-a. In some examples, the threshold distance (and corresponding coverage area) may be from the perspective of mobile device 115-a. Regardless of which device serves as the origin of the coverage area corresponding to the threshold distance, the threshold distance may represent the distance between two devices (e.g., a medical monitoring device 110 and mobile device 115) in which data retrieval decisions are made. In some case, a device (e.g., a medical monitoring device 110 or mobile device 115) may be associated with multiple threshold distances. In such cases, the device may include multiple RSSI values in one or more beacon signals.

In the example depicted in FIG. 2, mobile device 115-a may receive a broadcast beacon signal from medical monitoring device 110-a and determine the proximity of medical monitoring device 110-a (e.g., mobile device 115-a may determine that mobile device 115-a is within threshold distance 205, or within coverage area 210). Based on this determination, mobile device 115-a may display a user prompt. The user prompt may prompt the user of mobile device 115-a (e.g., clinician 105-b) to indicate whether the data collected by medical monitoring device 110-a should be received by, and displayed by, mobile device 115-a. Based on the response or input from the user, mobile device 115-a may receive and display data collected by medical monitoring device 110-a, or refrain from receiving data collected by medical monitoring device 110-a.

The mobile device 115-a may receive the medical data collected by medical monitoring device 110-a directly from medical monitoring device 110-a (e.g., via wireless communication link 150) or from a remote server (e.g., via network 125-a). In some cases, mobile device 115-a may also receive medical data associated with patient 105-a that is collected by medical monitoring devices other than medical monitoring device 110-a. For example, mobile device 115-a may receive medical data for patient 105-a from a remote server (e.g., via network 125-a). The supplemental medical data may be received automatically, or upon a request from mobile device 115-a (e.g., in response to a user input). The supplemental medical data may be received irrespective of which device is used to transmit the data collected by medical monitoring device 110-a. In some cases, the user of mobile device 115-a (e.g., clinician 105-b) may decide from which device to receive the data collected by medical monitoring device 110-a (e.g., via an interactive user display). In other cases, the transmitting device is selected automatically by mobile device 115-a.

In some cases, the rate at which medical monitoring device 110-a reports the medical data collected by medical monitoring device 110-a may be adjusted based on the proximity of mobile device 115-a. For instance, medical monitoring device 110-a may send medical data to a remote server (e.g., a remote server 135 described with reference to FIG. 1) at a first slower rate (e.g., once per hour) when mobile device 115-a is outside of threshold distance 205 and at a second faster rate (e.g., once per second) when mobile device 115-a is within threshold distance 205. Such an embodiment may enable clinician 105-b to monitor the effect of a medication just administered to patient 105-a. In some cases, the adjustment of the reporting rate may be by a remote server. For example, mobile device 115-a may detect that one or more medical monitoring devices 110 (e.g., medical monitoring device 110-a) are within (or outside) a threshold distance and indicate this information to the remoter server. In response, the remote server may signal the medical monitoring devices 110 to adjust (e.g., increase or decrease) their reporting rate. In another example, mobile device 115-a may signal the medical monitoring devices 110 directly with an indication to adjust their reporting rate based on a detected proximity to the medical monitoring devices 110. According to the indication, the medical monitoring devices 110 may adjust their reporting rate to the remote server or mobile device 115-a, or a combination of the two.

Medical monitoring device 110-a may verify the authority of mobile device 115-a prior to sending medical data to mobile device 115-a. For example, medical monitoring device 110-a may determine the identity of mobile device 115-a and compare it to a list of mobile device identities that are authorized to receive medical data for patient 105-a. If mobile device 115-a is on the authorized list, medical monitoring device 110-a may send the medical data to mobile device 115-a. If mobile device 115-a is not on the authorized list, medical monitoring device 110-a may refrain from sending medical data to mobile device 115-a. In some cases, medical monitoring device 110-a may also send a report (e.g., to a remote server or another mobile device) indicating that mobile device 115-a attempted to gain unauthorized access to the medical data.

Thus, mobile device 115-a may determine whether to receive data collected by medical monitoring device 110-a based on the proximity of medical monitoring device 110-a. Mobile device 115-a may also consider other factors when deciding whether to received data, and/or when determining what user prompts to display. For example, mobile device 115-a may adjust data reception and user prompt displays based on the proximity or alarm status of other medical monitoring devices. Mobile device 115-a may also adjust data reception and user prompt displays based on the relationship between the patient coupled with the medical monitoring device and a particular clinician.

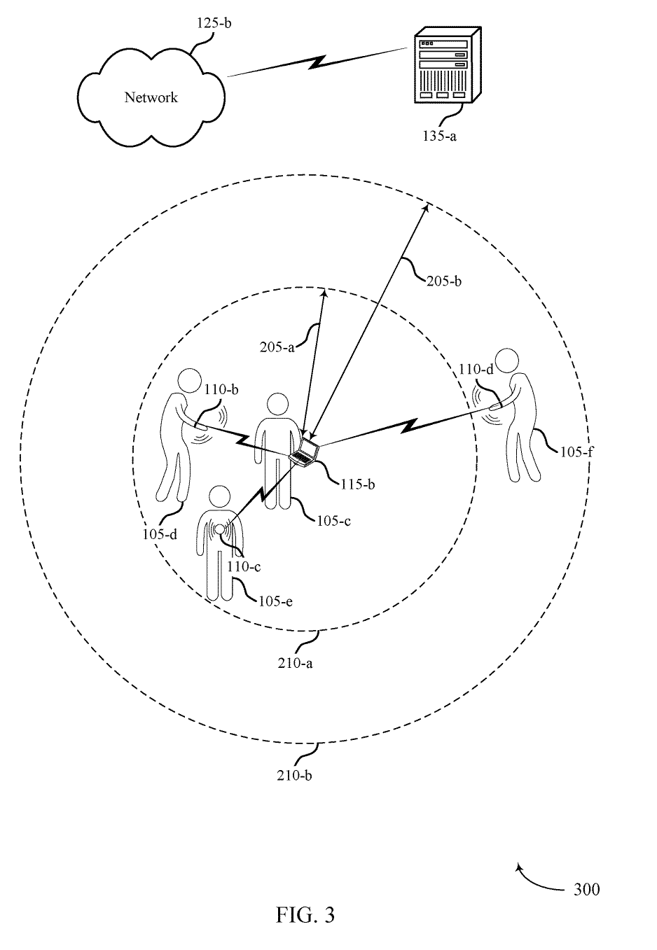

FIG. 3 illustrates an example of a wireless patient monitoring system 300 for proximity-based medical data retrieval. In some cases, wireless patient monitoring system 300 may represent aspects of techniques performed by a mobile device 115 as described with reference to FIGS. 1 and 2. Wireless patient monitoring system 300 may include mobile device 115-b, which may be operated by clinician 105-c. Wireless patient monitoring system 300 may also include medical monitoring device 110-b, medical monitoring device 110-c, and medical monitoring device 110-d, which may be examples of a medical monitoring device 110 described with reference to FIGS. 1 and 2. Medical monitoring device 110-b may collect medical data associated with patient 105-d, medical monitoring device 110-c may collect medical data associated with patient 105-e, and medical monitoring device 110-d may collect medical data associated with patient 105-f.

Medical monitoring device 110-b and medical monitoring device 110-c may be within a first threshold distance 205-a (e.g., 1 meter) from mobile device 115-b (e.g., medical monitoring device 110-b and medical monitoring device 110-c may be within coverage area 210-a). Put another way, mobile device 115-b may be within a first threshold distance (e.g., 1 meter) from medical monitoring device 110-b and medical monitoring device 110-c, respectively. Mobile device 115-b may determine the proximity of medical monitoring device 110-b based on a beacon signal transmitted (e.g., broadcast) by medical monitoring device 110-b. Mobile device 115-b may determine the proximity of medical monitoring device 110-c based on a beacon signal transmitted (e.g., broadcast) by medical monitoring device 110-c. The determination may be based on proximity detection information conveyed by the beacons (e.g., expected RSSI value) and/or the signal strength of the beacons (e.g., measured RSSI) such as described above, or using other proximity determination techniques.

Medical monitoring device 110-d may be within a second threshold distance 205-b (e.g., 5 meters) from mobile device 115-b (e.g., medical monitoring device 110-d may be within coverage area 210-b). Put another way, mobile device 115-b may be within a second threshold distance (e.g., 5 meters) from medical monitoring device 110-d. Mobile device 115-b may determine the proximity of medical monitoring device 110-d using the proximity determination techniques described herein, or other proximity determination techniques. Thus, mobile device 115-b may determine that the distance between mobile device 115-b and medical monitoring device 110-d is greater than the distance between mobile device 115-b and medical monitoring device 110-b, 110-c. Based on this determination, mobile device 115-b may prioritize reception of medical data from medical monitoring devices 110-b, 110-c over reception of medical data from medical monitoring device 110-d. For example, mobile device 115-b may not indicate to clinician 105-c that data reception from medical monitoring device 110-d is an option. In other cases, mobile device 115-b may indicate the option to receive data from medical monitoring device 110-d in a different manner than that used to indicate the option to receive data from medical monitoring devices 110-b, 110-c.

In some cases, mobile device 115-b may determine that patient 105-f is in more critical condition compared to patient 105-d and patient 105-e. For example, mobile device 115-b may detect that an alarm for medical monitoring device 110-d has been triggered. In such cases, mobile device 115-b may prioritize data from medical monitoring device 110-d over data from medical monitoring devices 110-b, 110-c. For instance, mobile device 115-b may automatically display the medical data from medical monitoring device 110-d.

When mobile device 115-b determines that multiple medical monitoring devices 110 are within the first threshold distance 205-a, mobile device 115-b may display a user input that prompts the user of mobile device 115-b (e.g., clinician 105-c) to select which medical monitoring device 110 from which to receive medical data. In some cases, mobile device 115-b may determine that medical monitoring device 110-b is associated with (e.g., coupled with) patient 105-d and that medical monitoring device 110-c is associated with (e.g., coupled with) patient 105-e. That is, mobile device 115-b may identify the patient 105 associated with each respective medical monitoring device 110. Mobile device 115-b may also determine that patient 105-d is unassociated with clinician 105-b and that patient 105-e is associated with clinician 105-b. For example, mobile device 115-b may determine that clinician 105-c is responsible for some aspect of care for patient 105-e. In some cases, mobile device 115-b may make this determination by accessing a patient list (e.g., a list that indicates the relationship between clinicians and patients). Mobile device 115-b may prioritize data reception from medical monitoring device 110-c over data reception from medical monitoring device 110-b based on the determined associations between the patients 105-d, 105-e and clinician 105-c. For example, mobile device 115-b may use a different display prompt that highlights medical monitoring device 110-c. Or mobile device 115-b may refrain from indicating to clinician 105-c that reception from medical monitoring device 110-b is possible.

In some cases, there may be more than one medical monitoring device 110 coupled with a patient 105. For example, patient 105-e may be coupled with multiple medical monitoring devices 110. Data from these medical monitoring devices 110 may also be received by mobile device 115-b individually (i.e., the mobile device 115-b may connect with each medical monitoring device 110 individually). In some cases, each medical monitoring device may transmit its own beacon signal and data retrieval may occur as described herein. In other cases, a control medical monitoring device (e.g., medical monitoring device 110-c) may be the only medical monitoring device that transmits beacon signals. In such cases, data collected by the other medical monitoring devices may be transmitted by the control medical monitoring device when appropriate. For example, the control medical monitoring device can obtain medical data from the other medical monitoring devices and relay the medical data to mobile device 115-b.

A medical monitoring device 110 may send data to mobile device 115-b, as described above. A medical monitoring device 110 may also send data to remote server 135-a (e.g., via network 125-b). The data may be sent automatically or upon request. Remote server 135-a may receive medical data from the medical monitoring device 110, and from other medical monitoring devices. The other medical monitoring devices may be associated with the same or different patients 105. Thus, remote server 135-a may aggregate data from multiple medical monitoring devices. In some cases, remote server 135-a may transmit some of the aggregated data to mobile device 115-b. The data may be the data from a single medical monitoring device (e.g., medical monitoring device 110-c), or from multiple medical monitoring device associated with the same patient (e.g., patient 105-e). The data may be sent upon request from medical monitoring device 110-c, or upon request from mobile device 115-b.

In some cases, remote server 135-a may obtain data from a medical monitoring device (e.g., medical monitoring device 110-c) indirectly. For instance, remote server 135-a may obtain data collected by a medical monitoring device 110 from mobile device 115-b (e.g., mobile device 115-b may receive the data collect by the medical monitoring device 110 and relay it to remote server 135-a). Mobile device 115-b may relay data to remote server 135-a from multiple medical monitoring devices that are coupled with the same or different patients. In some cases, the data may be re-formatted or converted (e.g., converted into a format supported by Ethernet, Wi-Fi, etc.) prior to sending the data to remote server 135-a.

In accordance with certain aspects, mobile device 115-b may connect to multiple medical monitoring devices 110 within the first threshold distance 205-a while ignoring medical monitoring devices outside of the first threshold distance 205-a (e.g., medical monitoring devices within the second threshold distance 205-b, such as medical monitoring device 110-d). For example, mobile device 115-b may receive one or more beacon signals from medical monitoring device 110-b, medical monitoring device 110-c, and medical monitoring device 110-d. Mobile device 115-b may use signal strength information of the beacon signals, as described above, to determine the respective proximities of the medical monitoring devices 110. Thus, mobile device 115-b may determine that medical monitoring device 110-b and medical monitoring device 110-c are closer (e.g., within the first threshold distance 205-a) than medical monitoring device 110-d. Mobile device 115-b may prioritize data retrieval from medical monitoring device 110-b and 110-c over that of medical monitoring device 110-d. For instance, according to a user response to a display prompt, medical monitoring device 115-b may receive data collected by medical monitoring device 110-b and 110-c (e.g., directly or indirectly) and refrain from receiving data collected by medical monitoring device 110-d. Thus, a mobile device 115-b may connect with, or retrieve data collected by, multiple medical monitoring devices 110 (e.g., worn by a single patient or multiple patients) based on their proximity relative to mobile device 115-b or relative to their proximity to other medical monitoring devices 110.

In some cases, mobile device 115-b may be a wired device (e.g., plugged in to a wall) and/or may not feature a display. In these or other cases, mobile device 115-b may retrieve (e.g., via wireless means) medical data collected by medical monitoring devices 110 when they come within a threshold distance. Mobile device 115-b may forward or relay the medical data to remote server 135-a. If more than one medical monitoring device 110 is within the threshold distance, mobile device 115-b may prioritize the retrieval and/or relaying of medical data based on the respective proximities of the medical monitoring devices 110 respective to mobile device 115-b (e.g., mobile device 115-b may give higher priority to a medical monitoring device that is closer to mobile device 115-b than its counterparts). When mobile device 115-b determines that a medical monitoring device is outside of a threshold distance, mobile device 115-b may refrain from retrieving medical data from the medical monitoring device 110 (e.g., mobile device 115-b may disconnect from the medical monitoring device).

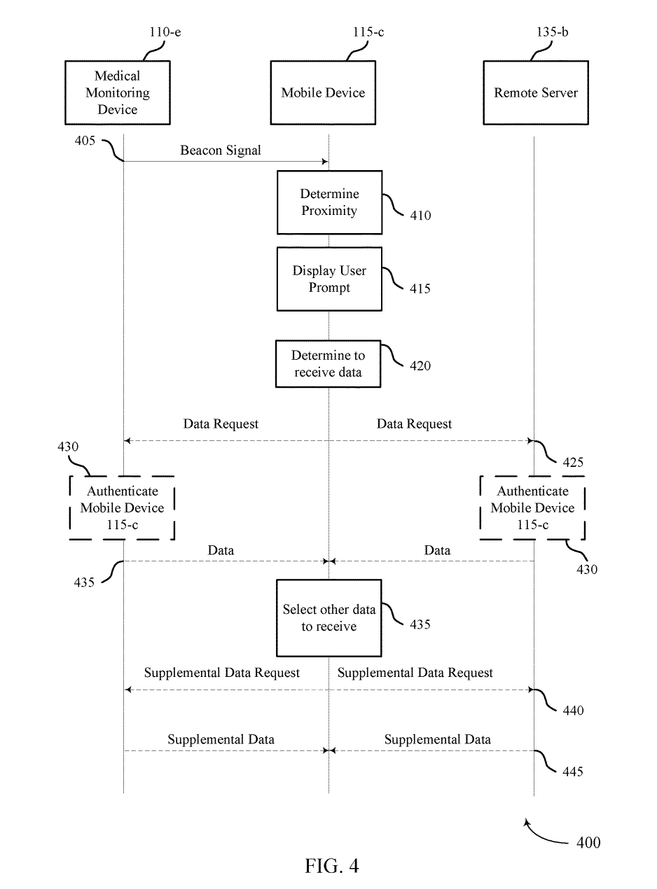

FIG. 4 illustrates an example of a process flow 400 for proximity-based medical data retrieval in accordance with various aspects of the present disclosure. Process flow 400 may include medical monitoring device 110-e, mobile device 115-c, and remote server 135-b, which may be examples of the corresponding devices described with reference to FIGS. 1-3. Medical monitoring device 110-e may be coupled with a patient. Mobile device 115-c may retrieve data collected by medical monitoring device 110-e by communicating with medical monitoring device 110-e and/or remote server 135-b.

At 405, medical monitoring device 110-e may transmit, and mobile device 115-c may receive, a beacon signal. The beacon signal may include proximity detection information (e.g., an expected RSSI value) and identification information (e.g., information identifying medical monitoring device 110-e). At 410, mobile device 115-c may determine the proximity of medical monitoring device 110-e based at least in part on the beacon signal. For example mobile device 115-c may compare the measured RSSI corresponding to the beacon signal and compare it to an expected RSSI value conveyed by the beacon signal. If the proximity is greater than a threshold distance, mobile device 115-b determine not to receive data collected by medical monitoring device 110-e. If the proximity is within a threshold distance, mobile device 115-b may, at 415 determine to display a user prompt that asks the user if they would like to receive data collected by medical monitoring device 110-e.

Mobile device 115-c may determine whether or not to receive data collected by medical monitoring device 110-e based on the user input responsive to the user prompt. For instance, mobile device 115-c may refrain from receiving the medical data if a negative indication results from the user prompt. If a positive indication results, the mobile device may, at 420, determine to receive the medical data and select a device from which to receive the data. Mobile device 115-c may select a device from which to receive the data automatically, or based on another user input. For example, mobile device 115-c may display a user prompt that asks the user which device (e.g., medical monitoring device 110-e or remote server 135-b) should provide the medical data to mobile device 115-c.

At 425, mobile device 115-c may send a data request to medical monitoring device 110-e or remote server 135-b. The request may be based on the selection of the device from which to receive the data. For example, if mobile device 115-c determines that the data should be transmitted from medical monitoring device 110-e, mobile device 115-c may send a data request to medical monitoring device 110-e. If mobile device 115-e determines that the data should be provided by remote server 135-b (e.g., via a network like the Internet), mobile device 115-e may send a data request to remote server 135-b. The data request may include information identifying mobile device 115-c, which may be used to verify the right of mobile device 115-c to request data. The data request may be communicated using Bluetooth, BLE, the Internet, or any other type of communication scheme or radio access technology.

At 430, the device providing the medical data (e.g., medical monitoring device 110-e or remote server 135-b) may authenticate mobile device 115-c. For example, the device may compare the identification information included in the data request to a list that indicates the devices that are authorized to access the medical data. If mobile device 115-c is authenticated, the transmitting device (e.g., medical monitoring device 110-e or remote server 135-b) may, at 435, send the requested medical data to mobile device 115-c. For example, medical monitoring device 110-e may transmit the data using Bluetooth or BLE, and remote server 135-b may send the data via a communications network such as the Internet.

At 440, mobile device 115-c may select supplemental data to receive, as well as the device from which to receive the supplemental data. The supplemental data may be data associated with the patient who is wearing medical monitoring device 110-e. In some cases, the supplemental data may be data from other medical monitoring devices that are coupled with the patient. Mobile device 115-c may determine the supplemental data to request, as well as the device (e.g., medical monitoring device 110-e or remote server 135-b) to provide the supplemental data, automatically or based on a user input (e.g., based on a user input that is responsive to a display prompt). In some cases, the supplemental data may be provided by the same device that provided the original medical data. In other cases, the supplemental data may be provided by a different device.

At 445, mobile device 115-c may send a supplemental data request according to the determinations at 440. For example, mobile device 115-c may send a supplemental data request to medical monitoring device 110-e and/or remote server 135-b. At 445, in response to the supplemental data request, medical monitoring device 110-e and/or remote server 135-b may send supplemental data to mobile device 115-c. In some cases, medical monitoring device 110-e and/or remote server 135-b may authenticate mobile device 115-c prior to sending the supplemental data.

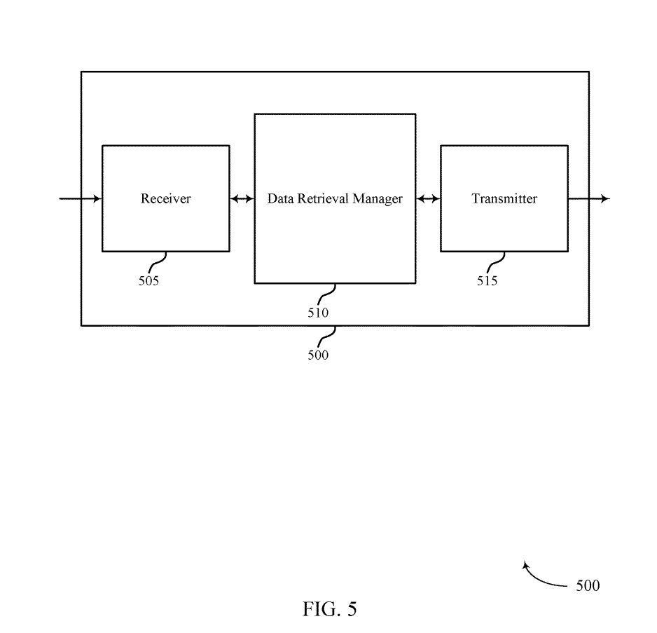

FIG. 5 shows a block diagram of a wireless device 500 that supports proximity-based medical data retrieval in accordance with various aspects of the present disclosure. Wireless device 500 may be an example of aspects of a mobile device 115 described with reference to FIGS. 1 and 2. Wireless device 500 may include receiver 505, data retrieval manager 510 and transmitter 515. Wireless device 500 may also include a processor. Each of these components may be in communication with each other.

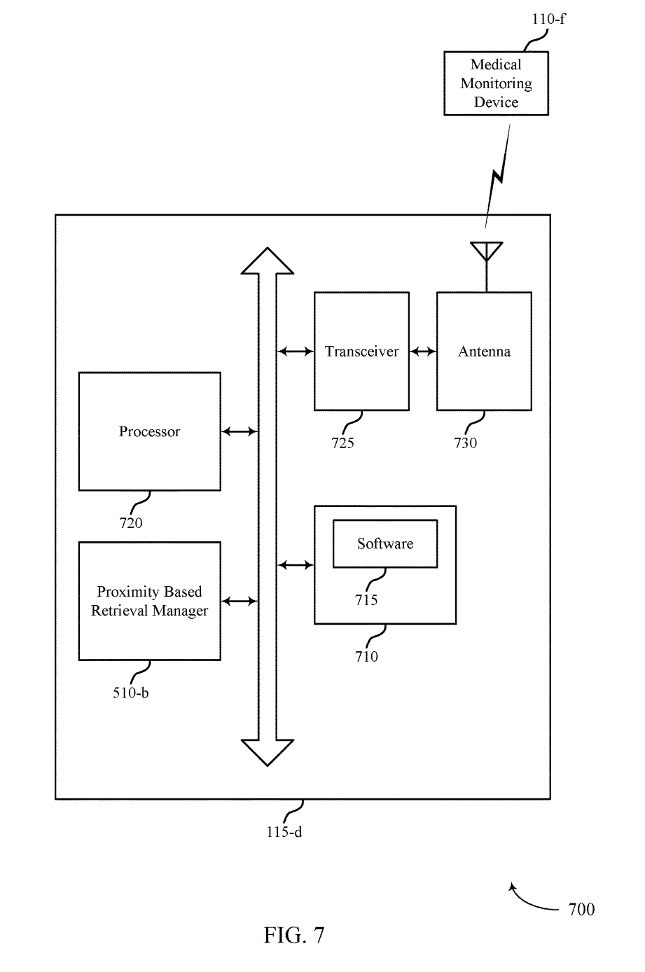

The receiver 505 may receive signals from one or more external devices (e.g., beacon signals from medical monitoring devices). The receiver 505 may receive the signals wirelessly (e.g., via BLE). The receiver 505 may communicate with other components of the wireless device 500. For example, the receiver 505 may pass data and information on to other components (e.g., to the data retrieval manager 510) of the wireless device 500. The receiver 505 may be an example of aspects of the transceiver 725 described with reference to FIG. 7.

The data retrieval manager 510 may receive (e.g., via receiver 505) one or more beacon signals from medical monitoring devices. For example, the data retrieval manager 510 may receive a first beacon signal from a first medical monitoring device. The data retrieval manager 510 may determine a proximity between the mobile device and the first medical monitoring device based on the first beacon signal. The data retrieval manager 510 may determine whether to receive medical data collected by the first medical monitoring device based at least in part on the determined proximity. The data retrieval manager 510 may also be an example of aspects of the data retrieval manager 510-b described with reference to FIG. 7.

The transmitter 515 may transmit signals received from other components of the wireless device 500. For example, the transmitter 515 may communicate with the data retrieval manager 510 to send messages to one or more external devices (e.g., a medical monitoring device and/or remote server). In some examples, the transmitter 515 may be collocated with a receiver in a transceiver module. For example, the transmitter 515 may be an example of aspects of the transceiver 725 described with reference to FIG. 7. The transmitter 515 may include a single antenna, or it may include a plurality of antennas.

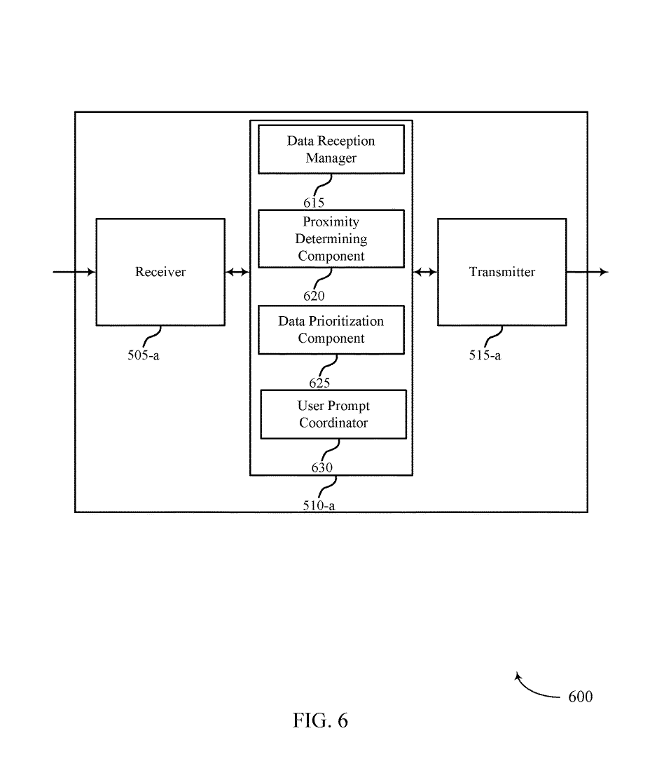

FIG. 6 shows a block diagram of a wireless device 600 that supports proximity-based medical data retrieval in accordance with various aspects of the present disclosure. Wireless device 600 may be an example of aspects of a wireless device 500 or a mobile device 115 described with reference to FIGS. 1, 2 and 5. Wireless device 600 may include receiver 505-a, data retrieval manager 510-a and transmitter 515-a. Wireless device 600 may also include a processor. Each of these components may be in communication with each other. Wireless device 600 may be configured to determine a proximity of a medical monitoring device based at least in part on a beacon signal received at the wireless device 600 from the medical monitoring device. Wireless device 600 may also be configured to determine whether to receive medical data collected by the medical monitoring device based at least in part on the determined proximity.

The receiver 505-a may receive signals which may be passed on to other components of the device. The receiver 505-a may also perform the functions described with reference to the receiver 505 of FIG. 5. For example the receiver 505-a may receive beacons signals (e.g., BLE beacon signals) from multiple medical monitoring devices. In certain embodiments, receiver 505-a may receive a first beacon signal from a first medical monitoring device and a second beacon from a second medical monitoring device. In some cases, receiver 505-a may wirelessly receive medical data from medical monitoring devices via BLE communications. In some examples, receiver 505-a may wirelessly receive medical data from medical monitoring devices from a remote server (e.g., via a network such as the Internet).

Transmitter 515-a may transmit signals received from other components of wireless device 600. For example, transmitter 515-a may send messages to a medical monitoring device or a remote server. In some examples, the transmitter 515-a may be collocated with a receiver in a transceiver module. For example, the receiver 505-a and transmitter 515-a may be an example of aspects of the transceiver 725 described with reference to FIG. 7. The transmitter 515-a may utilize a single antenna, or it may utilize a plurality of antennas. In some cases, the transmitter 515-a may transmit medical data to a remote server. The medical data may be data collected by, and received from, a medical monitoring device. The medical data may have a converted format. Transmitter 515-a may wireless communicate with other wireless device via BLE communications or via a network (e.g., the Internet).

Data retrieval manager 510-a may be an example of aspects of the data retrieval manager 510 described with reference to FIG. 5. Data retrieval manager 510-a may include data reception manager 615, proximity determining component 620, data prioritization component 625, and user prompt coordinator 630. Data retrieval manager 510-a may be an example of aspects of the data retrieval manager 510-b described with reference to FIG. 7. In some cases, data retrieval manager 510-a may identify a patient associated with a first medical monitoring device and receive, from a remote server, medical information collected by other medical monitoring devices associated with the patient.

The data reception manager 615 may include circuitry, logic, hardware and/or software for receiving beacon signals (e.g., via communications with receiver 505-a). For example, the data reception manager 615 may receive a first beacon from a first medical monitoring device. The first beacon signal may include proximity detection information (e.g., an RSSI value indication an expected RSSI at a first threshold) and/or information identifying the first medical monitoring device. In some embodiments, the data reception manager 615 may receive a second beacon from a second medical monitoring device. In certain embodiments, the data reception manager 615 may receive medical data collected by the first medical monitoring device from a remote server. In other embodiments, the data reception manager 615 may receive medical data collected by the first medical monitoring device directly from the first medical monitoring device. In some cases, the data reception manager 615 may convert the received medical data to a different format.

The proximity determining component 620 may include circuitry, logic, hardware and/or software for determining a proximity between the first medical monitoring device and wireless device 600. For example, the proximity determining component 620 may determine that wireless device 600 is within a first threshold distance of the first medical monitoring device. In some cases, determining the mobile device is within the first threshold distance includes comparing a measured RSSI of the first beacon signal at the mobile device to the expected RSSI value. In some embodiments, the proximity determining component 620 may determine a proximity between the second medical monitoring device and wireless device 600. For example, the proximity determining component 620 may determine that the proximity between wireless device 600 and the second mobile device is within the first threshold distance. In alternative example, the proximity determining component 620 may determine that the proximity between wireless device 600 and the second mobile device is within a second threshold distance that is greater than the first threshold distance.

The user prompt coordinator 630 may include circuitry, logic, hardware and/or software for facilitating the display of user prompts. For example, the user prompt coordinator 630 may coordinate the display of a user prompt based at least in part on a determination that wireless device 600 is within the first threshold distance. In such cases, wireless device 600 may determine whether to receive the medical data collected by the first medical monitoring device is based at least in part on a user input responsive to the user prompt. In some cases, user prompt coordinator 630 may facilitate the display of a user prompt to select one of the first or the second medical monitoring devices from which to receive medical data. In such cases, wireless device 600 may determine whether to receive the medical data collected by the first medical monitoring device is based at least in part on a user input responsive to the user prompt.

The data prioritization component 625 may include circuitry, logic, hardware and/or software for prioritizing the reception of medical data. For example, the data prioritization component 625 may determine that the first medical monitoring device is associated with a patient list and that the second medical monitoring device is unassociated with the patient list. In such cases, the data prioritization component 625 may prioritize reception of medical data from the first medical monitoring device over reception of medical data from the second medical monitoring device. The prioritization may be based at least in part on the determined associations. Wireless device 600 may determine whether to receive the medical data collected by the first medical monitoring device based at least in part on the prioritization.

In some examples, the data prioritization component 625 may prioritize reception of medical data from the first medical monitoring device over reception of medical data from the second medical monitoring device based at least in part on the determination that wireless device 600 is closer to the first medical monitoring device than the second medical monitoring device. Wireless device 600 may determine whether to receive the medical data collected by the first medical monitoring device based at least in part on the prioritization. In some embodiments, the data prioritization component 625 may detect that the first medical monitoring device has a triggered alarm. In such cases, the data prioritization component 625 may prioritize reception of medical data from the first medical monitoring device over reception of medical data from the second medical monitoring device. Wireless device 600 may determine whether to receive the medical data collected by the first medical monitoring device based at least in part on the detection

FIG. 7 shows a diagram of a system 700 that supports proximity-based medical data retrieval in accordance with various aspects of the present disclosure. System 700 may include mobile device 115-d, which may be an example of a mobile device 115, wireless device 500, or wireless device 600 as described with reference to FIGS. 1-6. System 700 may also include medical monitoring device 110-f, which may be an example of a medical monitoring device 110 described with reference to FIGS. 1-6. Medical monitoring device 110-f may be coupled with a patient and configured to collect medical data associated with the patient. Medical monitoring device 110-f may also be configured to transmit beacon signals. Mobile device 115-d may be configured to determine whether to receive medical data collected by medical monitoring device 110-f. The determination may be based at least in part on a proximity between medical monitoring device 110-f and mobile device 115-d. The proximity may be determined based at least in part on a beacon signal received from medical monitoring device 110-f. In some cases, medical monitoring device 110-f is configured to authenticate mobile device 115-d before mobile device 115-d can receive the medical data.

Mobile device 115-a may include data retrieval manager 510-b, memory 710, processor 720, transceiver 725, and antenna(s) 730. Each of these modules may communicate, directly or indirectly, with one another (e.g., via one or more buses). The data retrieval manager 510-b may be an example of a data retrieval manager as described with reference to FIGS. 5 and 6. The memory 710 may be in electronic communication with the processor 720 and may include random access memory (RAM) and read only memory (ROM). The memory 710 may store computer-readable, computer-executable software including instructions that, when executed, cause the processor 720 to perform various functions described herein (e.g., proximity-based medical data retrieval, etc.). In some cases, the software 715 may not be directly executable by the processor but may cause a computer (e.g., when compiled and executed) to perform functions described herein. The processor 720 may include an intelligent hardware device, (e.g., a central processing unit (CPU), a microcontroller, an application specific integrated circuit (ASIC), etc.).

The transceiver 725 may communicate bi-directionally, via one or more antennas, wired, or wireless links, with one or more networks, as described above. The transceiver 725 may also include a modem to modulate the packets and provide the modulated packets to the antennas for transmission, and to demodulate packets received from the antennas. In some cases, the wireless device may include a single antenna 730. However, in some cases the device may have more than one antenna 730, which may be capable of concurrently transmitting or receiving multiple wireless transmissions.

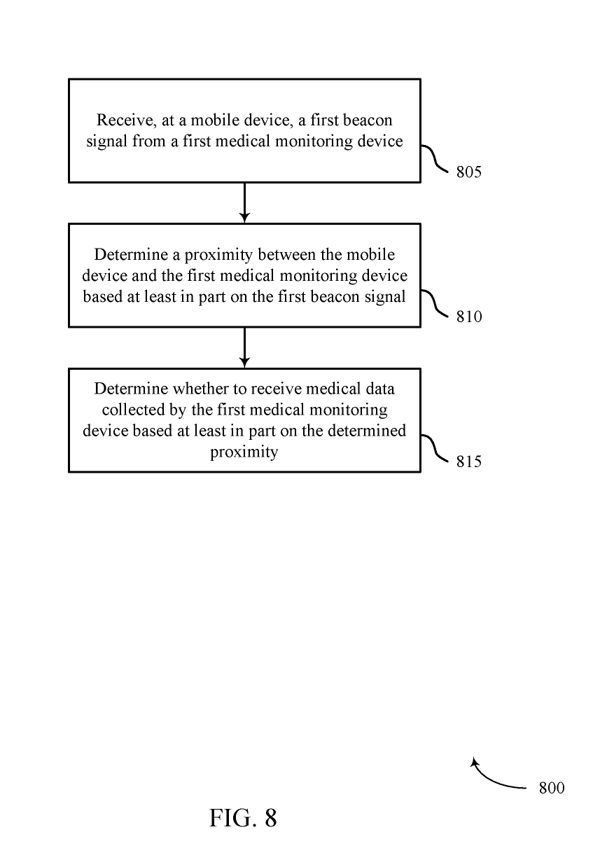

FIG. 8 shows a flowchart illustrating a method 800 for proximity-based medical data retrieval in accordance with various aspects of the present disclosure. The operations of method 800 may be implemented by a device such as a mobile device 115 or its components as described with reference to FIGS. 1-7. For example, the operations of method 800 may be performed by the data retrieval manager as described herein. In some examples, the mobile device 115 may execute a set of codes to control the functional elements of the device to perform the functions described below. Additionally or alternatively, the mobile device 115 may perform aspects the functions described below using special-purpose hardware.

At block 805 the method may include receiving, at mobile device 115, a first beacon signal from a first medical monitoring device as described above with reference to FIGS. 2-4. The first beacon signal may include an RSSI value indicating an expected RSSI at the first threshold distance. The first beacon signal may also include information identifying the first medical monitoring device. In certain examples, the operations of block 805 may be performed by the data reception component as described with reference to FIG. 6.

At block 810, the method may include determining a proximity between the mobile device and the first medical monitoring device based at least in part on the first beacon signal as described above with reference to FIGS. 2-4. In some cases, determining the proximity includes determining that the mobile device is within a first threshold distance of the first medical monitoring device. The mobile device may determine that the mobile device is within a first threshold distance by comparing the RSSI value conveyed by the beacon signal to a measured RSSI associated with the beacon signal. In certain examples, the operations of block 810 may be performed by the proximity determining component as described with reference to FIG. 6.

At block 815, the mobile device 115 may determine whether to receive medical data collected by the first medical monitoring device based on the determined proximity as described above with reference to FIGS. 2-4. In some cases, the method may further include receiving the medical data based at least in part on the determination, converting (or reformatting) the received medical data into a different format, and sending the converted medical data to a remote server. In some embodiments, receiving the medical data includes receiving the medical data from a remote server. In other embodiments, receiving the medical data includes receiving the medical data directly from the first medical monitoring device. In some examples, the method may include identifying a patient associated with the first medical monitoring device. In such examples, the method may also include receiving, from the remote server, medical information collected by other medical monitoring devices associated with the patient. In certain examples, the operations of block 815 may be performed by the data reception component or the prioritization component as described with reference to FIG. 6.

In some cases, the method claim include receiving a second beacon signal from a second medical monitoring device and determining a proximity between the mobile device and the second monitoring device is within a second threshold distance. The proximity may be based at least in part on the second beacon signal. The second threshold distance may be greater than the first threshold distance. In some examples, the method may include prioritizing reception of medical data from the first medical monitoring device over reception of medical data from the second medical monitoring device. In such examples, determining whether to receive the medical data collected by the first medical monitoring device may be based at least in part on the prioritization.

In some examples, the method includes detecting that the first medical monitoring device has a triggered alarm. In such examples, the mobile device 115 may prioritize reception of medical data from the first medical monitoring device over reception of medical data from the second medical monitoring device. Thus, determining whether to receive the medical data collected by the first medical monitoring device may be based at least in part on the detection. In some cases, the method may include determining that the first medical monitoring device is associated with a patient list and that the second medical monitoring device is unassociated with the patient list. In such cases, the mobile device 115 may prioritize reception of medical data from the first medical monitoring device over reception of medical data from the second medical monitoring device based at least in part on the determined associations. Thus, determining whether to receive the medical data collected by the first medical monitoring device may be based at least in part on the prioritization

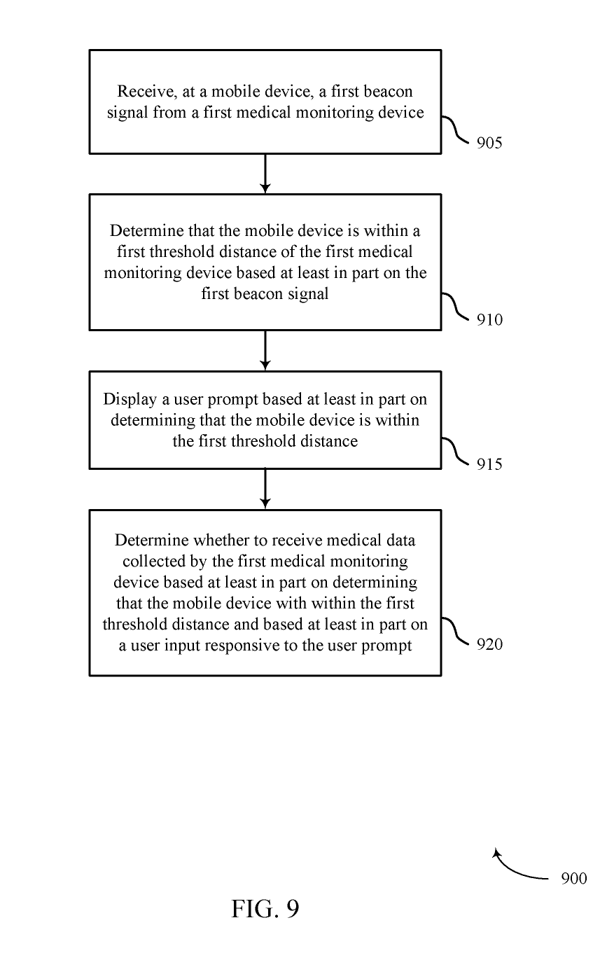

FIG. 9 shows a flowchart illustrating a method 900 for proximity-based medical data retrieval in accordance with various aspects of the present disclosure. The operations of method 900 may be implemented by a device such as a mobile device 115 or its components as described with reference to FIGS. 1-8. For example, the operations of method 900 may be performed by the data retrieval manager as described herein. In some examples, the mobile device 115 may execute a set of codes to control the functional elements of the device to perform the functions described below. Additionally or alternatively, the mobile device 115 may perform aspects the functions described below using special-purpose hardware.

At block 905 the method may include receiving, at the mobile device 115, a first beacon signal from a first medical monitoring device as described above with reference to FIGS. 2-4. In certain examples, the operations of block 905 may be performed by the beacon component as described with reference to FIG. 6. At block 910, the method may include determining that the mobile device is within a first threshold distance of the first medical monitoring device based on the first beacon signal as described above with reference to FIGS. 2-4. In certain examples, the operations of block 910 may be performed by the proximity determining component as described with reference to FIG. 6.

At block 915, the method may include displaying a user prompt based at least in part on determining that the mobile device is within the first threshold distance as described above with reference to FIGS. 2-4. In certain examples, the operations of block 915 may be performed by the user prompt coordinator as described with reference to FIG. 6. At block 920, the method may include determining whether to receive medical data collected by the first medical monitoring device based on determining that the mobile device is within a first threshold distance and based at least in part on a user input response to the user prompt as described above with reference to FIGS. 2-4. In certain examples, the operations of block 920 may be performed by the data reception manager as described with reference to FIG. 6.

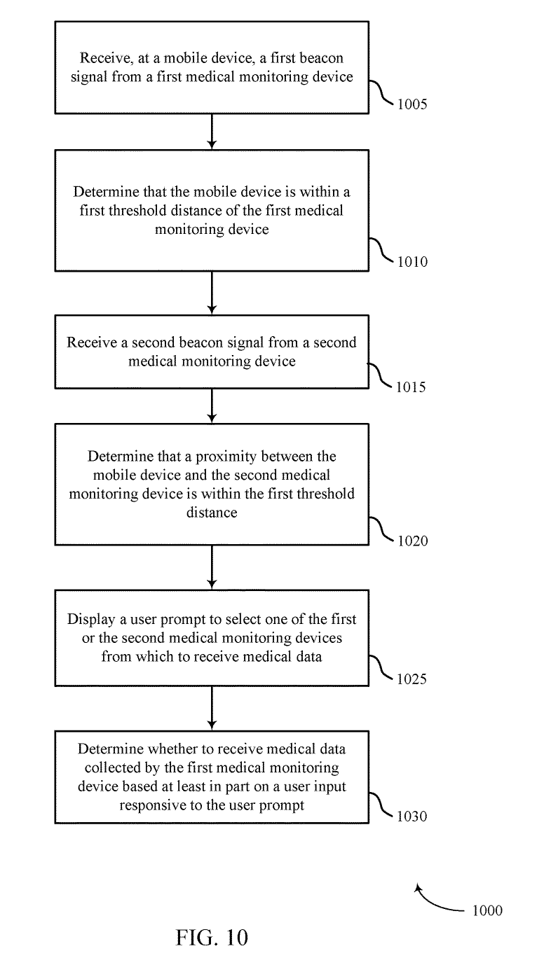

FIG. 10 shows a flowchart illustrating a method 1000 for proximity-based medical data retrieval in accordance with various aspects of the present disclosure. The operations of method 1000 may be implemented by a device such as a mobile device 115 or its components as described with reference to FIGS. 1-8. For example, the operations of method 1000 may be performed by the data retrieval manager as described herein. In some examples, the mobile device 115 may execute a set of codes to control the functional elements of the device to perform the functions described below. Additionally or alternatively, the mobile device 115 may perform aspects the functions described below using special-purpose hardware.

At block 1005 the method may include receiving, at the mobile device 115, a first beacon signal from a first medical monitoring device as described above with reference to FIGS. 2-4. In certain examples, the operations of block 1005 may be performed by the data reception manager as described with reference to FIG. 6. At block 1010, the method may include determining that the mobile device is within a first threshold distance of the first medical monitoring device based on the first beacon signal as described above with reference to FIGS. 2-4. In certain examples, the operations of block 1010 may be performed by the proximity determining component as described with reference to FIG. 6.

At block 1015, the method may include receiving a second beacon signal from a second a medical monitoring device as described above with reference to FIGS. 2-4. In certain examples, the operations of block 1015 may be performed by the user prompt coordinator as described with reference to FIG. 6. At block 1020, the method may include determining that a proximity between the mobile device and the second medical monitoring device is within the threshold distance as described above with reference to FIGS. 2-4. In certain examples, the operations of block 1020 may be performed by the data reception manager as described with reference to FIG. 6.

At block 1025, the method may include displaying a user prompt to select one of the first or second medical monitoring devices from which to receive medical data as described above with reference to FIGS. 2-4. In certain examples, the operations of block 1025 may be performed by the user prompt coordinator as described with reference to FIG. 6. At block 1030, the method may include determining whether to receive medical data collected by the first medical monitoring device based at least in part on a user input responsive to the user prompt as described above with reference to FIGS. 2-4. In certain examples, the operations of block 1030 may be performed by the data reception manager as described with reference to FIG. 6.

It should be noted that these methods describe possible implementation, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein. Thus, aspects of the disclosure may provide for proximity-based medical data retrieval.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical (PHY) locations. Also, as used herein, including in the claims, “or” as used in a list of items (for example, a list of items prefaced by a phrase such as “at least one of” or “one or more”) indicates an inclusive list such that, for example, a list of at least one of A, B, or C means A or B or C or AB or AC or BC or ABC (i.e., A and B and C).

Thus, aspects of the disclosure may provide for proximity-based medical data retrieval. It should be noted that these methods describe possible implementations, and that the operations and the steps may be rearranged or otherwise modified such that other implementations are possible. In some examples, aspects from two or more of the methods may be combined.

The various illustrative blocks and modules described in connection with the disclosure herein may be implemented or performed with a general-purpose processor, a digital signal processor (DSP), an ASIC, an field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be performed by one or more other processing units (or cores), on at least one integrated circuit (IC). In various examples, different types of ICs may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

What is claimed is:

1. A method of proximity-based retrieval of medical data, comprising:
receiving, at a mobile device, a first beacon signal from a first medical monitoring device;
determining a proximity between the mobile device and the first medical monitoring device based at least in part on the first beacon signal; and
determining whether to receive medical data collected by the first medical monitoring device based at least in part on the determined proximity.

2. The method of claim 1, wherein determining the proximity between the first medical monitoring device and the mobile device comprises:
determining that the mobile device is within a first threshold distance of the first medical monitoring device.

3. The method of claim 2, further comprising:
displaying a user prompt based at least in part on determining that the mobile device is within the first threshold distance, wherein determining whether to receive the medical data collected by the first medical monitoring device is based at least in part on a user input responsive to the user prompt.

4. The method of claim 2, further comprising:
receiving, at the mobile device, a second beacon signal from a second medical monitoring device;
determining that a proximity between the mobile device and the second medical monitoring device is within the first threshold distance; and
displaying a user prompt to select one of the first or the second medical monitoring devices from which to receive medical data, wherein determining whether to receive the medical data collected by the first medical monitoring device is based at least in part on a user input responsive to the user prompt.

5. The method of claim 2, wherein the first beacon signal comprises a received signal strength indicator (RSSI) value indicating an expected RSSI at the first threshold distance.

6. The method of claim 5, wherein determining that the mobile device is within the first threshold distance comprises:
comparing a measured RSSI of the first beacon signal at the mobile device to the RSSI value.

7. The method of claim 1, further comprising:
receiving, at the mobile device, a second beacon signal from a second medical monitoring device;
determining that the first medical monitoring device is associated with a patient list and that the second medical monitoring device is unassociated with the patient list; and
prioritizing reception of medical data from the first medical monitoring device over reception of medical data from the second medical monitoring device based at least in part on the determined associations, wherein determining whether to receive the medical data collected by the first medical monitoring device is based at least in part on the prioritization.

8. The method of claim 1, further comprising:
determining that the mobile device is within a first threshold distance of the first medical monitoring device;
receiving, at the mobile device, a second beacon signal from a second medical monitoring device;
determining that a proximity between the mobile device and the second medical monitoring device is within a second threshold distance that is greater than the first threshold distance, wherein the determined proximity is based at least in part on the second beacon signal; and
prioritizing reception of medical data from the first medical monitoring device over reception of medical data from the second medical monitoring device, wherein determining whether to receive the medical data collected by the first medical monitoring device is based at least in part on the prioritization.

9. The method of claim 1, further comprising:
receiving, at the mobile device, a second beacon signal from a second medical monitoring device;
detecting that the first medical monitoring device has a triggered alarm; and
prioritizing reception of medical data from the first medical monitoring device over reception of medical data from the second medical monitoring device, wherein determining whether to receive the medical data collected by the first medical monitoring device is based at least in part on the detection.

10. The method of claim 1, further comprising:
receiving the medical data based at least in part on the determination;
converting the received medical data to a different format; and
transmitting the converted medical data to a remote server.

11. The method of claim 1, wherein receiving the medical data collected by the first medical monitoring device comprises receiving the medical data from a remote server.

12. The method of claim 1, wherein receiving the medical data collected by the first medical monitoring device comprises receiving the medical data directly from the first medical monitoring device.

13. The method of claim 12, further comprising:
identifying a patient associated with the first medical monitoring device; and
receiving, from a remote server, medical information collected by other medical monitoring devices associated with the patient.

14. The method of claim 1, wherein the first beacon signal further comprises information identifying the first medical monitoring device.

15. A mobile device for proximity-based retrieval of medical data, comprising:
a processor;
memory in electronic communication with the processor; and
instructions stored in the memory and operable, when executed by the processor, to cause the mobile device to:
determine a proximity between a medical monitoring device and the mobile device based at least in part on a beacon signal received at the mobile device from the medical monitoring device; and
determine whether to receive medical data collected by the medical monitoring device based at least in part on the determined proximity.

16. The mobile device of claim 15, wherein the beacon signal is a Bluetooth Low Energy (BLE) beacon signal.

17. The mobile device of claim 15, wherein the instructions are operable to cause the processor to wirelessly receive the medical data from the medical monitoring device via Bluetooth Low Energy (BLE) communications.

18. The mobile device of claim 15, wherein the instructions are operable to cause the processor to wirelessly receive the medical data from a remote server via the Internet.

19. A system for proximity-based retrieval of medical data, comprising:
a medical monitoring device coupled with a patient and configured to collect medical data associated with the patient and transmit a beacon signal; and
a mobile device configured to determine whether to receive the medical data collected by the medical monitoring device, the determination based at least in part on a proximity between the medical monitoring device and the mobile device, wherein the proximity is determined based at least in part on the beacon signal.

20. The system of claim 19, wherein the medical monitoring device is configured to authenticate the mobile device before the mobile device can receive the medical data.
